(19) United States
(12) Patent Application Publication
(10) Pub. No.: US 2024/0372124 A1
(43) Pub. Date: Nov. 7, 2024

(54) Fuel Cell Stack Module

(71) Applicant: Robert Bosch GmbH, Stuttgart (DE)

(72) Inventors: Kai Wang, Shanghai (CN); Liyun Fu, Shanghai (CN); Yafei Chang, Shanghai (CN); Ze Chen, Shanghai (CN)

(21) Appl. No.: 18/687,738

(22) PCT Filed: Sep. 24, 2021
(86) PCT No.: PCT/CN2021/120324

§ 371 Date: Feb. 28, 2024

(51) Int. Cl. H01M 8/2484; H01M 8/04007; H01M 8/04089; H01M 8/04791; H01M 8/247

(52) U.S. Cl. CPC H01M 8/2484; H01M 8/04007; H01M 8/04097; H01M 8/04798; H01M 8/247

(57) ABSTRACT

A fuel cell stack module includes at least one shared end plate and at least two fuel cell stacks arranged to share the at least one shared end plate. Each of the at least two fuel cell stacks is individually clamped. The fuel cell stack module can integrate more cells within a limited space to provide higher power density, and can also maintain uniform clamping forces and effective sealing within the respective fuel cell stacks to prevent leakage.

### TECHNICAL FIELD

The present disclosure relates to a fuel cell stack, and relates in particular to a fuel cell stack module having a shared end plate.

### BACKGROUND

Fuel cells have broad development prospects due to advantages such as high energy conversion efficiency and low pollution, and are currently widely applied in many fields. For example, a fuel cell stack composed of a plurality of fuel cells and end plates on two sides can be used to power electric vehicles. Commercial vehicles and large passenger cars require greater power and therefore require greater stack power, which requires a stack including more cells. However, it is difficult for a stack including more cells to maintain uniform clamping forces, and it is difficult to ensure sealing to avoid leakage. Therefore, the current general practice is to divide a larger stack into a plurality of smaller stacks, which typically results in a decrease in the power density of the stack.

In addition, in the configuration of a current fuel cell stack, components such as a pump for pumping fuel, an oxidant, an coolant, etc., and a valve for adjusting the flow thereof are typically installed outside the fuel cell stack, and thus need to occupy an additional volume, which will further result in a decrease in the power density of the fuel cell stack. In addition, since a cathode exhaust gas recirculation (EGR) channel of the current fuel cell stack is too long, cathode exhaust gases will experience a greater temperature drop when flowing through the channel, thereby causing the water vapor therein to condense and clog the channel, and affecting the smooth progression of exhaust gas recirculation.

Therefore, there is a need in the art for a fuel cell stack capable of solving the above problems.

### SUMMARY

An objective of the present disclosure is to provide a fuel cell stack module to solve at least some of the above problems.

Provided in the present disclosure is a fuel cell stack module, comprising: at least one shared end plate; and at least two fuel cell stacks arranged to share the at least one shared end plate, wherein each of the at least two fuel cell stacks is individually clamped.

In an embodiment, the at least two fuel cell stacks are sequentially arranged in a direction generally from left to right, and the shared end plate is provided between every two adjacent fuel cell stacks.

In an embodiment, the fuel cell stack module further comprises a first outer side end plate and a second outer side end plate, and the at least two fuel cell stacks comprise a first fuel cell stack and a second fuel cell stack, the first fuel cell stack being clamped between the first outer side end plate and a shared end plate, and the second fuel cell stack module being clamped between the second outer side end plate and a shared end plate.

In an embodiment, the at least two fuel cell stacks are arranged in the form of a ring, and the shared end plate is provided between every two adjacent fuel cell stacks, each of the at least two fuel cell stacks being clamped between shared end plates on two sides thereof.

In an embodiment, the at least one shared end plate has a size in a longitudinal direction that is greater than the size of the at least two fuel cell stacks in the longitudinal direction, so that a plurality of fuel cell stacks are arranged in the longitudinal direction on either side of the shared end plate.

In an embodiment, the at least one shared end plate is configured in the form of a polygonal prism, and the fuel cell stacks are arranged on at least two of a plurality of sides of the at least one shared end plate.

In an embodiment, each of the at least two fuel cell stacks comprises the same or a different number of fuel cells.

In an embodiment, each of the at least one shared end plate is internally provided with a plurality of inlets, channels and outlets, and fuel, an oxidant and a coolant flow into the respective fuel cell stacks via different inlets and channels, and flow out of the shared end plate via different outlets.

In an embodiment, each of the at least one shared end plate is further internally provided with a temperature sensor, a relative humidity sensor, a pressure sensor, and a concentration sensor used for measuring working parameters of the fuel, the oxidant, and the coolant.

In an embodiment, the channels comprise a cathode exhaust gas recirculation channel, and an exhaust gas recirculation pump is provided in the cathode exhaust gas recirculation channel.

In an embodiment, the plurality of inlets and outlets comprise an oxidant inlet and an oxidant outlet, the oxidant flows into the shared end plate via the oxidant inlet and is divided into two parts, a first part of the oxidant flows into a first fuel cell stack on a first side of the shared end plate and a second part of the oxidant flows into a second fuel cell stack on a second side of the shared end plate, cathode exhaust gases generated by reactions gather and flow back to the oxidant outlet of the shared end plate, a part of the cathode exhaust gases flows into the cathode exhaust gas recirculation channel under the action of the exhaust gas recirculation pump, and another part of the cathode exhaust gases is discharged from the shared end plate via the oxidant outlet.

In an embodiment, the shared end plate is provided with a first diverter valve used for adjusting the ratio of the first part of the oxidant to the second part of the oxidant.

In an embodiment, the plurality of inlets and outlets comprise an oxidant inlet and an oxidant outlet, the oxidant flows into the shared end plate via the oxidant inlet and is divided into two parts, a first part of the oxidant flows into a first fuel cell stack on a first side of the shared end plate, and cathode exhaust gases generated by reactions and a second part of the oxidant are mixed and then flow into a second fuel cell stack on a second side of the shared end plate, cathode exhaust gases generated by reactions gather and flow back to the oxidant outlet of the shared end plate, a part of the cathode exhaust gases flows into the cathode exhaust gas recirculation channel under the action of the exhaust gas recirculation pump, and another part of the cathode exhaust gases is discharged from the shared end plate via the oxidant outlet.

In an embodiment, the shared end plate is provided with a second diverter valve used for adjusting the ratio of the first part of the oxidant to the second part of the oxidant.

In an embodiment, the first fuel cell stack and the second fuel cell stack comprise the same number of fuel cells, and the ratio of the first part of the oxidant to the second part of the oxidant is greater than 1:1.

The fuel cell stack module according to the present disclosure can integrate more cells within a limited space to provide higher power density, and can also maintain uniform clamping forces and effective sealing within the respective fuel cell stacks to prevent leakage. In addition, various sensors and actuators (valves, pumps, etc.) are integrated within the shared end plate of the fuel cell stack module, which simplifies the structure of the fuel cell stack module and reduces the volume, thereby further increasing power density. Finally, the cathode exhaust gas recirculation channel disposed within the shared end plate is greatly shortened, thereby preventing water vapor in the cathode exhaust gases from condensing and clogging the channel.

### BRIEF DESCRIPTION OF THE DRAWINGS

The drawings are provided to help readers more thoroughly understand the present disclosure, wherein

FIG. 1 schematically shows a fuel cell stack module according to an embodiment of the present disclosure;

FIG. 2 schematically shows an oxidant flow channel of a fuel cell stack module according to an embodiment of the present disclosure; and

FIG. 3 schematically shows an oxidant flow channel of a fuel cell stack module according to another embodiment of the present disclosure.

### DETAILED DESCRIPTION

The present disclosure will be described below by specific embodiments. It should be understood that the specific embodiments are provided for the purpose of facilitating a thorough understanding of the present disclosure only, and are not intended to limit the present disclosure. Therefore, the following embodiments are merely exemplary, and the scope of protection of the present disclosure is defined only by the appended claims.

FIG. 1 schematically shows a fuel cell stack module according to an embodiment of the present disclosure. As shown in FIG. 1, the fuel cell stack module includes: two fuel cell stacks, that is, a first fuel cell stack 11 and a second fuel cell stack 12; a shared end plate 2 sandwiched between the first fuel cell stack 11 and the second fuel cell stack 12; and a first outer side end plate 31 and a second outer side end plate 32, which are provided on an outer side of the first fuel cell stack 11 and an outer side of the second fuel cell stack 12, respectively.

Each of the first fuel cell stack 11 and the second fuel cell stack 12 includes a plurality of cells stacked together, and each cell can independently perform a chemical reaction to generate electrical energy, thereby providing greater power through the plurality of cells. To avoid unnecessarily obscuring the focus of the present disclosure, the specific structure of the fuel cell will not be described in detail here. It will be understood by those skilled in the art that the cells of the fuel cell stack according to the present disclosure may be any suitable fuel cells, such as hydrogen-oxygen fuel cells, etc.

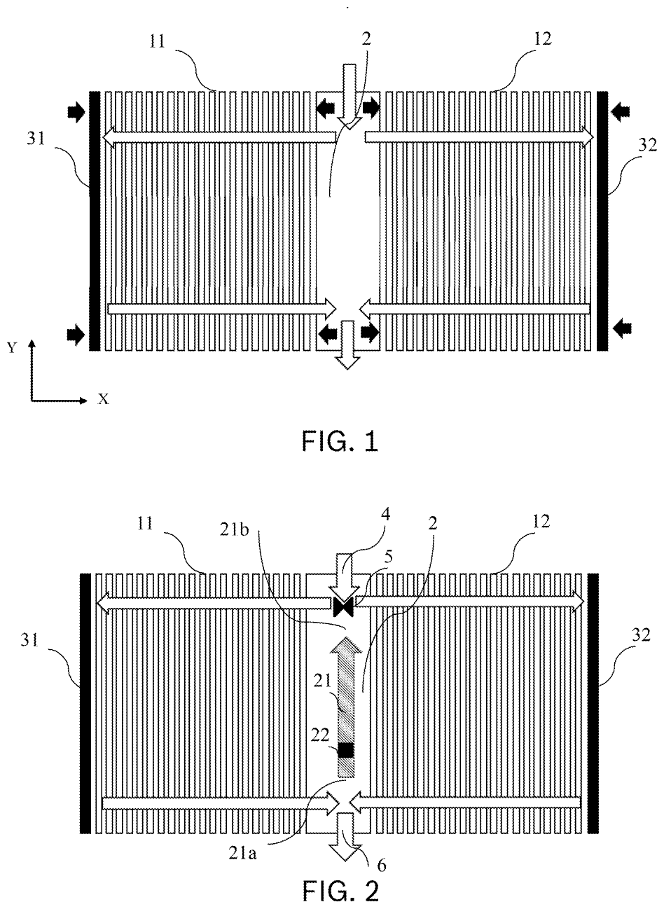

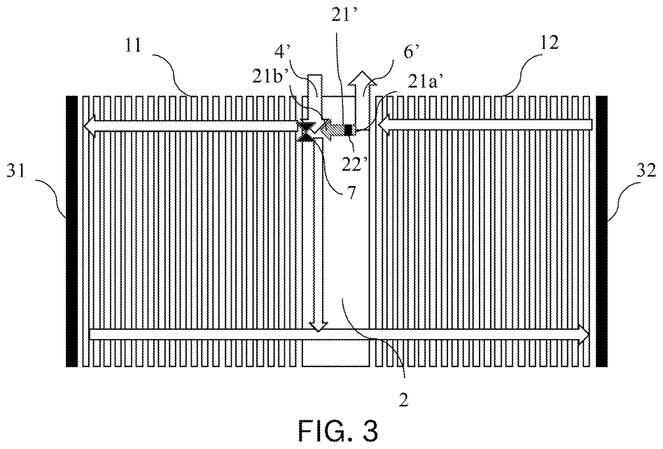

The shared end plate 2 can support the fuel cell stacks on two sides thereof, and is further provided with a plurality of fluid inlets, channels and outlets (which will be described in detail below with reference to FIGS. 2 and 3). Fluids such as fuel, an oxidant and a coolant can flow into the respective fuel cell stacks via different inlets and channels, so as to enter respective cells to carry out a chemical reaction or to cool the respective cells, and subsequently flow out via different outlets. The white arrows in FIG. 1 schematically show oxidant flow paths in the fuel cell stack module.

The plurality of cells of the first fuel cell stack 11 are clamped between the first outer side end plate 31 and the shared end plate 2 by means of fasteners such as screws, etc., and the plurality of cells of the second fuel cell stack 12 are clamped between the second outer side end plate 32 and the shared end plate 2 by means of fasteners such as screws, etc. The black arrows in FIG. 1 schematically show the directions of action of clamping forces acting on the respective fuel cell stacks.

By means of the above configuration, the fuel cell stack module according to the present disclosure can integrate more cells within a limited space, thereby providing higher power density. Also, since the first fuel cell stack 11 and the second fuel cell stack 12 are individually clamped between end plates on two sides (the shared end plate 2 and the outer side end plates 31, 32) rather than being clamped as a whole as in the prior art, uniform clamping forces and effective sealing are maintained within the respective fuel cell stacks, thereby preventing leakage.

The fuel cell stack module according to the present disclosure is not limited to the above configuration, and may include more than two fuel cell stacks and/or more than one shared end plate.

In another embodiment according to the present disclosure, the fuel cell stack module may include a plurality of fuel cell stacks sequentially arranged in a direction generally from left to right (which may be the linear transverse direction as shown by X in FIG. 1, or any other suitable non-linear direction), and one shared end plate 2 is provided between every two adjacent fuel cell stacks. Alternatively, the fuel cell stack module may include a plurality of fuel cell stacks arranged in the form of a ring, and one shared end plate 2 is provided between every two adjacent fuel cell stacks. In this case, the entire fuel cell stack module is in the shape of a ring connected end to end, so the first outer side end plate 31 and the second outer side end plate 32 described above may not be included, and each fuel cell stack may be individually clamped between the shared end plates 2 on two sides thereof.

In yet another embodiment according to the present disclosure, the size of the shared end plate 2 in a longitudinal direction (as shown by Y in FIG. 1) may be greater than the size of the first fuel cell stack 11 and the second fuel cell stack 12 in the longitudinal direction. For example, the size of the shared end plate 2 in the longitudinal direction may be twice the size of the first fuel cell stack 11 and the second fuel cell stack 12 in the longitudinal direction, so that two fuel cell stacks may be provided in the longitudinal direction on either side of the shared end plate 2.

In yet another embodiment according to the present disclosure, the shared end plate 2 may be configured in the form of a polygonal prism, and fuel cell stacks are provided on at least two of a plurality of sides of the polygonal prism. By way of example, the shared end plate may be configured in the form of a hexagonal prism, and fuel cell stacks are provided on at least two of the six sides thereof. The at least two of the six sides may be arranged adjacent to each other, opposite to each other, or spaced apart from each other. For example, one fuel cell stack may be provided on each of the six sides of the hexagonal prism, or a plurality of fuel cell stacks are provided in a longitudinal direction on each of the six sides, so that all of the fuel cell stacks share a shared end plate at the center.

The various configurations described above enable the fuel cell stack module to integrate more cells within a limited volume, thereby providing higher power density. It will be understood by those skilled in the art that the fuel cell stack module according to the present disclosure may further include any other suitable configuration.

In addition, in the various configurations described above, the respective fuel cell stacks of the fuel cell stack module may include the same or different numbers of cells depending on a specific application.

The shared end plate 2 may further be internally provided with a temperature sensor, a relative humidity sensor, a pressure sensor, a concentration sensor (not shown in the figures), etc., so that the temperatures, relative humidities, pressures, concentrations, etc. of the fluids flowing through the flow channels can be adjusted on the basis of measurement results of the above sensors, so as to optimize the performance of the fuel cell stack module. The specific setting positions of the above sensors may be determined according to parameters expected to be measured by the sensors.

In addition, a cathode exhaust gas recirculation channel is provided within the shared end plate 2, and an exhaust gas recirculation pump is provided within the cathode exhaust gas recirculation channel, which will be described in further detail below with reference to FIGS. 2 and 3. In this way, a part of cathode exhaust gases can flow into the fuel cell stack again via the cathode exhaust gas recirculation channel under the action of the exhaust gas recirculation pump, so as to undergo a chemical reaction. Compared with the conventional configuration in which the cathode exhaust gas recirculation channel is arranged outside the end plate, the present configuration shortens the length of the cathode exhaust gas recirculation channel, thereby preventing water vapor in the cathode exhaust gases from condensing and clogging the channel. In addition, since the cathode exhaust gas recirculation channel is provided within the shared end plate 2, heat generated from a fuel cell stack reaction adjacent to the shared end plate 2 may further prevent water vapor condensation.

FIG. 2 schematically shows an oxidant flow channel of a fuel cell stack module according to an embodiment of the present disclosure, and FIG. 3 schematically shows an oxidant flow channel of a fuel cell stack module according to another embodiment of the present disclosure. Taking a hydrogen-oxygen fuel cell as an example, the oxidant thereof is typically compressed air compressed by an air compressor.

As shown in FIG. 2, the shared end plate 2 is provided with an oxidant inlet 4 and an oxidant outlet 6 at two ends thereof, respectively, and is internally provided with a cathode exhaust gas recirculation channel 21. The cathode exhaust gas recirculation channel 21 includes a channel inlet 21a and a channel outlet 21b, and is provided with an exhaust gas recirculation pump 22 therein. The channel inlet 21a is in fluid communication with the oxidant outlet 6 of the shared end plate 2, and the channel outlet 21b is in fluid communication with the oxidant inlet 4 of the shared end plate 2. Fresh compressed air flows into the shared end plate 2 via the oxidant inlet 4 and is divided into two parts, a first part flows into the first fuel cell stack 11 and a second part flows into the second fuel cell stack 12 to undergo chemical reactions, and cathode exhaust gases generated by the reactions gather and flow back to the oxidant outlet 6 of the shared end plate. A part of the cathode exhaust gases is discharged from the shared end plate 2 via the oxidant outlet 6, and another part of the cathode exhaust gases then flows into the cathode exhaust gas recirculation channel 21 under the action of the exhaust gas recirculation pump 22 and flows to the channel outlet 21b for cathode exhaust gas recirculation. Since the channel outlet 21b is in fluid communication with the oxidant inlet 4 of the shared end plate 2, the part of the exhaust gases flowing thereto can flow into the respective fuel cell stacks again together with the fresh compressed air to undergo chemical reactions. In this way, the remaining oxygen in the cathode exhaust gases can be effectively used. In addition, since the cathode exhaust gases typically contain more water vapor, the fresh compressed air flowing in from the oxidant inlet 4 can be humidified thereby, which can reduce the need for additional humidifiers and may even eliminate the need for additional humidifiers.

The shared end plate 2 may further be provided with a first diverter valve 5 at the oxidant inlet 4, and by controlling the first diverter valve 5, the ratio of the first part to the second part of the compressed air can be adjusted to meet actual usage requirements. For example, if the number of cells included in the first fuel cell stack 11 is greater than the number of cells included in the second fuel cell stack 12, the first diverter valve 5 can be controlled such that the ratio of the first part to the second part of the compressed air is the same or similar to the ratio of the number of cells included in the fuel cell stacks, thereby allowing the respective cells to obtain a substantially consistent supply of oxidant. Alternatively, even if the first fuel cell stack 11 and the second fuel cell stack 12 include the same number of cells, the first diverter valve 5 can be controlled such that the amounts of the first part and the second part of the compressed air are different, thereby allowing the first fuel cell stack 11 and the second fuel cell stack 12 to provide different electrical powers.

The oxidant flow channel of the fuel cell stack module shown in FIG. 3 will be specifically described below. As shown in FIG. 3, the shared end plate 2 is provided with an oxidant inlet 4′ and an oxidant outlet 6′ at the same end, and is internally provided with a cathode exhaust gas recirculation channel 21′. The cathode exhaust gas recirculation channel 21′ includes a channel inlet 21a′ and a channel outlet 21b′, and is provided with an exhaust gas recirculation pump 22′ therein. The channel inlet 21a′ is in fluid communication with the oxidant outlet 6′ of the shared end plate 2, and the channel outlet 21b′ is in fluid communication with the oxidant inlet 4′ of the shared end plate 2. Fresh compressed air flows into the shared end plate 2 via the oxidant inlet 4′ and is divided into two parts, a first part flows into the first fuel cell stack 11 to undergo chemical reactions, and cathode exhaust gases generated by the reactions gather and then flow out from the first fuel cell stack 11, are mixed with a second part of the fresh compressed air, and then flow together therewith into the second fuel cell stack 12 to undergo chemical reactions. The second part of the fresh compressed air can be used to ensure that the concentration of the air flowing into the second fuel cell stack 12 meets the requirements. Cathode exhaust gases generated by the reactions in the second fuel cell stack 12 gather and then flow to the oxidant outlet 6′ of the shared end plate 2, a part of the cathode exhaust gases is discharged from the shared end plate 2 via the oxidant outlet 6′, and another part of the cathode exhaust gases enters the cathode exhaust gas recirculation channel 21′ under the action of the exhaust gas recirculation pump 22′ and flows to the channel outlet 21b′. Since the channel outlet 21b′ is in fluid communication with the oxidant inlet 4′ of the shared end plate 2, the part of the cathode exhaust gases flowing thereto can enter the cells of the first fuel cell stack 11 again together with fresh compressed air to undergo chemical reactions. The configuration of the oxidant flow channel shown in FIG. 3 can achieve effects similar to those of the oxidant flow channel shown in FIG. 2. In addition, since the cathode exhaust gases generated by the reactions in the first fuel cell stack 11 contain a certain amount of water vapor, when the cathode exhaust gases are mixed with the second part of the fresh compressed air, the second part of the fresh compressed air can be humidified, which can improve the performance of the second fuel cell stack 12 while reducing the need for additional humidifiers.

The shared end plate 2 may further be provided with a second diverter valve 7 at the oxidant inlet 4′, and by controlling the second diverter valve 7, the ratio of the first part to the second part of the compressed air can be adjusted to meet actual usage requirements. For example, when the first fuel cell stack 11 and the second fuel cell stack 12 include the same number of cells, the second diverter valve 7 can be controlled such that the ratio of the first part to the second part of the compressed air is greater than 1:1. In this way, the respective cells in the first fuel cell stack 11 and the second fuel cell stack 12 can obtain a substantially uniform supply of compressed air.

When the shared end plate 2 is provided with the second diverter valve 7 at the oxidant inlet 4′, and the compressed air flowing from the oxidant inlet 4′ is divided into a first part and a second part by means of a first outlet and a second outlet of the second diverter valve 7, the channel outlet 21b′ of the cathode exhaust gas recirculation channel 21′ can be directly in fluid communication with the first outlet of the second diverter valve 7, so that the cathode exhaust gases flowing out from the channel outlet 21b′ are directly mixed with the first part of the compressed air to only humidify the first part of the compressed air.

In the embodiments shown in FIGS. 2 and 3, the cathode exhaust gas recirculation channels 21 and 21′, the first diverter valve 5 and the second diverter valve 7, and the pumps 22 and 22′ and so on are all disposed within the shared end plate 2, which simplifies the structure of the entire fuel cell stack module and reduces the volume, thereby increasing the power density of the fuel cell stack module.

In addition, FIGS. 2 and 3 show only the oxidant flow channel of the fuel cell stack module. Those skilled in the art would understand that channels for fluids such as fuel and a coolant are further provided within the fuel cell stack module, and that the fluids can flow into a fuel channel and a coolant channel of the fuel cell stack module via different inlets provided on the shared end plate 2, and flow out via different outlets provided on the shared end plate 2.

The first diverter valve 5 shown in FIG. 2 and the second diverter valve 7 shown in FIG. 3 may be electrically controlled valves, so that the valves can be electrically controlled in real time according to actual usage needs.

It should be noted that the terms “first,” “second” or the like in the description and claims of the present disclosure are only used to distinguish between similar objects, and are not used to describe a particular sequence or order. It should be understood that objects prefixed by “first,” “second” or the like are interchangeable under appropriate circumstances.

Although the specific embodiments of the present disclosure are disclosed above, those skilled in the art would understand that various modifications, substitutions, and variations can be made without departing from the spirit and scope of the present disclosure. Therefore, the scope of the present disclosure is not limited to the specific embodiments described above, but is defined only by the appended claims.

1. A fuel cell stack module, by comprising:
at least one shared end plate; and
at least two fuel cell stacks arranged to share the at least one shared end plate, wherein each of the at least two fuel cell stacks is individually clamped.

2. The fuel cell stack module according to claim 1, wherein the at least two fuel cell stacks are sequentially arranged in a direction generally from left to right, and the shared end plate is provided between every two adjacent fuel cell stacks.

3. The fuel cell stack module according to claim 2, wherein the fuel cell stack module further comprises a first outer side end plate and a second outer side end plate, and the at least two fuel cell stacks comprise a first fuel cell stack and a second fuel cell stack, the first fuel cell stack being clamped between the first outer side end plate and a shared end plate, and the second fuel cell stack being clamped between the second outer side end plate and a shared end plate.

4. The fuel cell stack module according to claim 1, wherein the at least two fuel cell stacks are arranged in the form of a ring, and the shared end plate is provided between every two adjacent fuel cell stacks, each of the at least two fuel cell stacks being clamped between shared end plates on two sides thereof.

5. The fuel cell stack module according to claim 1, wherein the at least one shared end plate has a size in a longitudinal direction that is greater than the size of the at least two fuel cell stacks in the longitudinal direction, so that a plurality of fuel cell stacks are arranged in the longitudinal direction on either side of the shared end plate.

6. The fuel cell stack module according to claim 1, wherein the at least one shared end plate is configured in the form of a polygonal prism, and the fuel cell stacks are arranged on at least two of a plurality of sides of the at least one shared end plate.

7. The fuel cell stack module according to claim 1, wherein each of the at least two fuel cell stacks comprises the same or a different number of fuel cells.

8. The fuel cell stack module according to claim 1, wherein each of the at least one shared end plate is internally provided with a plurality of inlets, channels and outlets, and fuel, an oxidant and a coolant flow into the respective fuel cell stacks via different inlets and channels, and flow out of the shared end plate via different outlets.

9. The fuel cell stack module according to claim 8, wherein each of the at least one shared end plate is further internally provided with a temperature sensor, a relative humidity sensor, a pressure sensor, and a concentration sensor configured to measure working parameters of the fuel, the oxidant, and the coolant.

10. The fuel cell stack module according to claim 8, wherein the channels comprise a cathode exhaust gas recirculation channel, and an exhaust gas recirculation pump is provided in the cathode exhaust gas recirculation channel.

11. The fuel cell stack module according to claim 10, wherein the plurality of inlets and outlets comprise an oxidant inlet and an oxidant outlet, the oxidant flows into the shared end plate via the oxidant inlet and is divided into two parts, a first part of the oxidant flows into a first fuel cell stack on a first side of the shared end plate and a second part of the oxidant flows into a second fuel cell stack on a second side of the shared end plate, cathode exhaust gases generated by reactions gather and flow back to the oxidant outlet of the shared end plate, a part of the cathode exhaust gases flows into the cathode exhaust gas recirculation channel under the action of the exhaust gas recirculation pump, and another part of the cathode exhaust gases is discharged from the shared end plate via the oxidant outlet.

12. The fuel cell stack module according to claim 11, wherein the shared end plate is provided with a first diverter valve configured to adjust the ratio of the first part of the oxidant to the second part of the oxidant.

13. The fuel cell stack module according to claim 10, wherein the plurality of inlets and outlets comprise an oxidant inlet and an oxidant outlet, the oxidant flows into the shared end plate via the oxidant inlet and is divided into two parts, a first part of the oxidant flows into a first fuel cell stack on a first side of the shared end plate, and cathode exhaust gases generated by reactions and a second part of the oxidant are mixed and then flow into a second fuel cell stack on a second side of the shared end plate, cathode exhaust gases generated by reactions gather and flow back to the oxidant outlet of the shared end plate, a part of the cathode exhaust gases flows into the cathode exhaust gas recirculation channel under the action of the exhaust gas recirculation pump, and another part of the cathode exhaust gases is discharged from the shared end plate via the oxidant outlet.

14. The fuel cell stack module according to claim 13, wherein the shared end plate is provided with a second diverter valve configured to adjust the ratio of the first part of the oxidant to the second part of the oxidant.

15. The fuel cell stack module according to claim 14, wherein the first fuel cell stack and the second fuel cell stack comprise the same number of fuel cells, and the ratio of the first part of the oxidant to the second part of the oxidant is greater than 1:1.
